(19) United States
(12) Patent Application Publication
(10) Pub. No.: US 2012/0001712 A1
(43) Pub. Date: Jan. 5, 2012

(54) TRANSFORMERS

(76) Inventors: Silviu Puchianu, Portishead (GB); Steven Lewis Simpson, Bristol (GB); Graham Thomas Morley, Bristol (GB)

(21) Appl. No.: 13/166,498

(22) Filed: Jun. 22, 2011

(30) Foreign Application Priority Data
Jun. 30, 2010 (EP) 10167903.3
Apr. 20, 2011 (EP) 11163260.0

(51) Int. Cl. H01F 27/02; H01F 27/24

(52) U.S. Cl. 336/94; 336/212

(57) ABSTRACT

A transformer is provided. The transformer includes a core formed from a plurality of planar laminations stacked together adjacent one another to lie substantially parallel. The transformer also includes electrically insulating spacing means provided between each of the laminations and a lamination adjacent thereto to separate them so as to provide a plurality of voids in the core, each of which is between a lamination and a lamination adjacent thereto. The transformer further includes an electrically insulating fluid located within and filling said voids.

### BACKGROUND OF THE INVENTION

Embodiments of the present invention relate to a transformer, a transformer enclosure, an underwater facility and a subsea hydrocarbon extraction facility.

In underwater, for example subsea, electrical power distribution applications, transformers are increasingly used in pressure-compensated enclosures. The transformer is housed in an enclosure containing oil, and when deployed under water, the oil pressure is made equal to the external water pressure so the transformer may therefore operate in oil at very high pressures, for example equivalent to 3,000 m depth or more. The magnetic core of the transformer is typically formed from varnish-covered core-elements, and such high pressures can have a damaging effect upon these. Such varnished-covered core-elements are typically shaped as “I” and “E” profiles, though other form-factors may be used. The core elements may be formed from metals such as steel, or nickel/iron alloys etc.

FIGS. 1 to 3 illustrate a typical simple 50 Hz transformer construction with an iron/nickel alloy core. This comprises a plurality of laminations, typically between 0.5 and 0.35 mm thick. The laminations shown comprise core-elements of the so-called the “I” and “F” profiles, 1 and 2 respectively. During the assembly process shown schematically in FIG. 2, for each lamination, the centre arm 3 of the “E” core-element 2 is passed through the centre of a bobbin 4, which carries the required windings. The “E” core-element 2 is arranged to butt up to the “I” core-element 1. Each lamination is assembled in the reverse sense to its adjacent lamination(s), as shown in FIG. 2, where for the second layer of laminations, the “E” core-element 5, is assembled in the opposite direction to the first “E” core-element 2 and butts up to an “I” core-element 6 at the opposite end of the bobbin 4 to the first “I” core-element 1. The process is continued to form a stack of laminations as shown as part-assembled in FIG. 2, and the complete assembled stack is held together with nuts 9 and screwed rods 8 (shown in FIG. 3) located through holes 7 in the core-elements, with only one nut 9 on each rod 8 being shown. An end-on view of the transformer when partially assembled is shown in FIG. 3.

One of the most common pressure-related failure modes is as follows: under pressure, the core-elements may be “pushed” one against the other, such that there is a possibility of the varnish being damaged. This can result in short-circuits between the core-elements and, consequently, higher than normal induced electrical currents, which may cause the core to heat up. This temperature increase may dramatically decrease the efficiency of the transformer and could result in its destruction.

It is an aim of the embodiments of the present invention to overcome these problems. This aim is achieved by the provision of a transformer construction which distributes pressure evenly throughout the transformer core, so that core-elements are not unduly pressed together.

### BRIEF DESCRIPTION OF THE INVENTION

According to an embodiment of the present invention, a transformer is provided. The transformer includes a core formed from a plurality of planar laminations stacked together adjacent one another to lie substantially parallel. The transformer also includes electrically insulating spacing means provided between each of the laminations and a lamination adjacent thereto to separate them so as to provide a plurality of voids in the core, each of which is between a lamination and a lamination adjacent thereto. The transformer further includes an electrically insulating thud located within and filling said voids.

According to an embodiment of the present invention, a transformer enclosure is provided. The transformer enclosure includes a housing filled with electrically insulating fluid. The transformer enclosure also includes a transformer mounted within the housing, the transformer comprising a core formed from a plurality of planar laminations stacked together adjacent one another to lie substantially parallel and electrically insulating spacing means provided between each of the laminations and a lamination adjacent thereto to separate them so as to provide a plurality of voids in the core, each of which is between a lamination and a lamination adjacent thereto, said electrically insulating fluid also being located within and filling said voids. The transformer further includes a bladder configured to transfer the pressure external to the housing to the fluid in the housing such that in use the fluid resides at substantially the same pressure as that external to the enclosure.

According to an embodiment of the present invention, an underwater facility comprising a transformer is provided. The transformer includes a core formed from a plurality of planar laminations stacked together adjacent one another to lie substantially parallel. The transformer also includes electrically insulating spacing means provided between each of the laminations and a lamination adjacent thereto to separate them so as to provide a plurality of voids in the core, each of which is between a lamination and a lamination adjacent thereto. The transformer further includes an electrically insulating fluid located within and filling said voids.

According to an embodiment of the present invention, a subsea hydrocarbon extraction facility comprising a transformer is provided. The transformer includes a core formed from a plurality of planar laminations stacked together adjacent one another to lie substantially parallel. The transformer also includes electrically insulating spacing means provided between each of the laminations and a lamination adjacent thereto to separate them so as to provide a plurality of voids in the core, each of which is between a lamination and a lamination adjacent thereto. The transformer further includes an electrically insulating fluid located within and filling said voids

Embodiments of the present invention provide various advantages over the prior art. A transformer in accordance with the embodiments of the present invention is a much more reliable device in high barometric pressure environments, for example subsea, thus saving the substantial costs often incurred shortly after a conventional transformer fails or becomes unacceptably lossy after it is installed. While it is apparent that the performance of such a transformer will be reduced compared to the conventional design due to the reduction of ferrous density of the core, this loss will be by design and can be allowed for in the well system design rather than resulting from unexpected degradation after installation.

### BRIEF DESCRIPTION OF THE DRAWINGS

Embodiments of the present invention will now be described with reference to the accompanying drawings, in which:

FIG. 1 schematically shows in exploded view a portion of a known transformer;

FIG. 2 schematically shows a method of manufacturing the transformer of FIG. 1;

FIG. 3 schematically shows an end view of the assembled transformer of FIGS. 1 and 2;

FIG. 4 schematically shows a perspective view of two core-elements in accordance with an embodiment of the present invention;

FIG. 5 schematically shows an end-on view of a transformer assembled in accordance with an embodiment of the present invention; and

FIG. 6 schematically shows a pressure-equalizing transformer enclosure in accordance with an embodiment of the present invention.

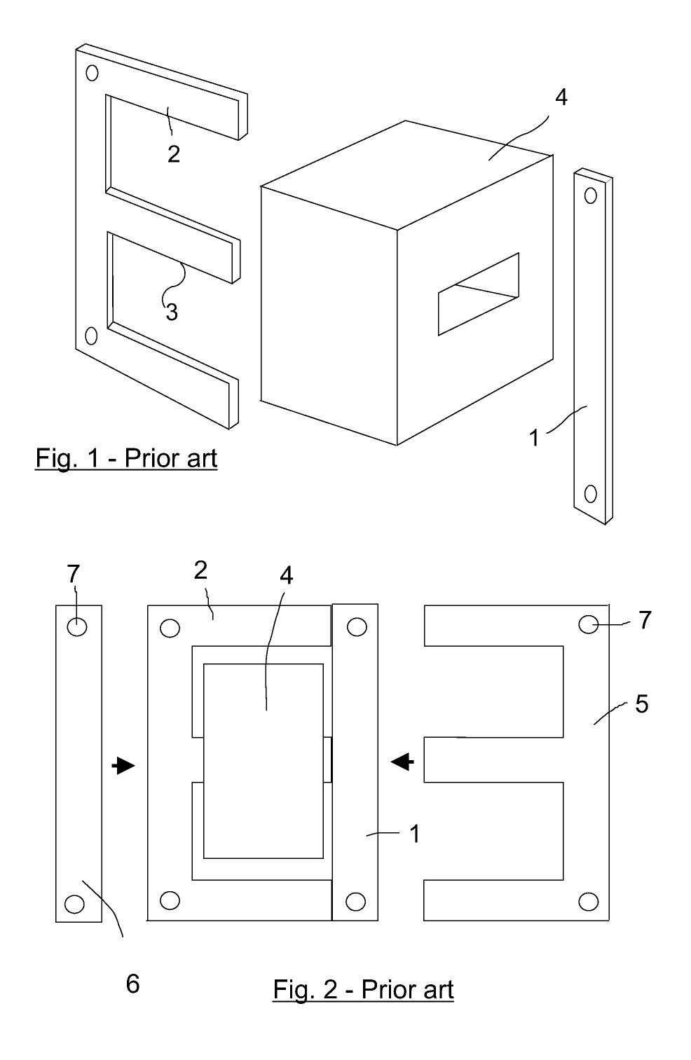

### DETAILED DESCRIPTION OF THE INVENTION

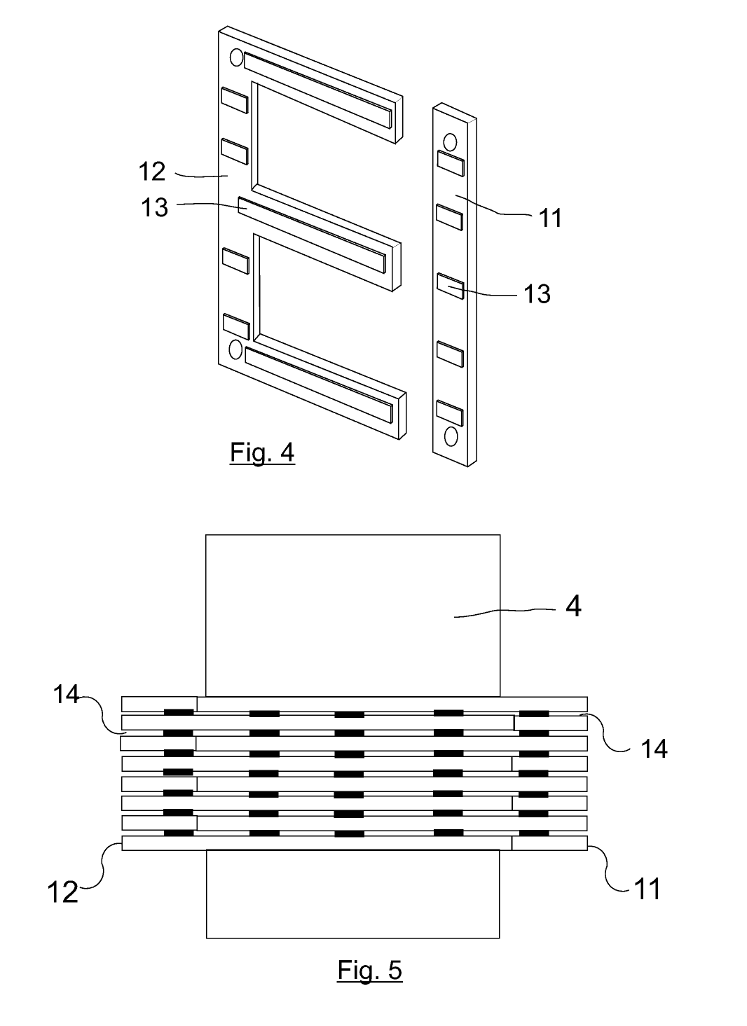

FIG. 4 illustrates “I” and “F” core-elements 11 and 12 respectively for a transformer in accordance with an embodiment of the present invention. As in the prior art transformer previously described, the thickness of each core element 11, 12 is between about 0.35 and 0.5 mm. A multiplicity of electrically insulating spacers 13 are fixed to one side of each core-element with a suitable adhesive. On each of core-elements 11, 12, the spacers 13 are of the same thickness, and are distributed about the surface of the core-element. When assembled together in a stack for forming the laminations of a transformer, the elements are maintained substantially in parallel by virtue of the spacers 13. In addition, the spacers 13 are arranged to be non-touching, i.e. they are spaced to maintain gaps between the spacers 13, so that oil may flow around them when the transformer is being filled with oil (see below). The spacers 13 are substantially planar, having a thickness of about one third of the thickness of the core-elements 11 and 12, i.e. between about 0.12 and 0.17 mm. The spacers 13 are formed from an electrically insulating material which is inert to oil, for example mica, polycarbonate, melamine or PTFE sheet. The spacers 13 are elongate, and are attached to the core-elements 11, 12 such that their major axes align with the direction of sliding of the core-elements through the bobbin 4 on assembly, i.e. substantially parallel to the “arms” of “E” element 12.

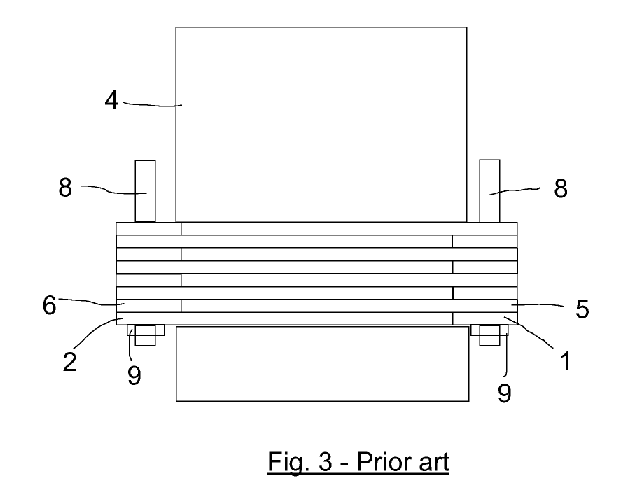

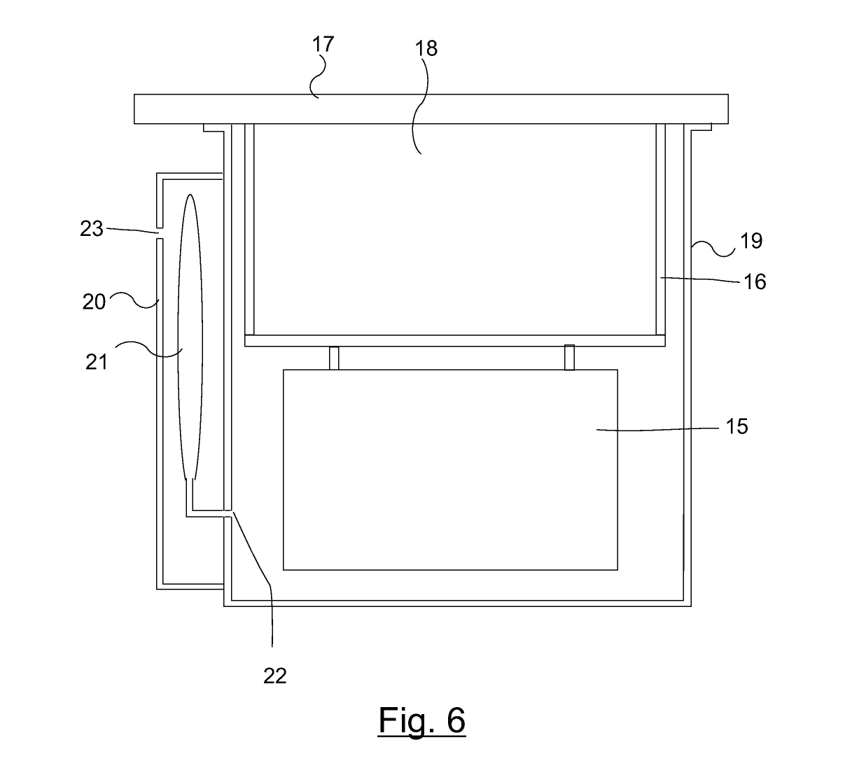

FIG. 5 schematically shows an assembled stack of core elements 11 and 12. As can be seen, unlike a conventional stack, here spaces or voids 14 are formed between the laminations, defined by the planar surfaces of the core-elements and the edges of the spacers 13. That is, the spacers 13 provide voids 14 in the core, there being such a void between each and every lamination and a lamination adjacent thereto. The voids 14 form channels between the core-elements with a width substantially equal to the thickness of the spacers 13. The transformer is housed in a container filled with electrically insulating oil (see FIG. 6 and as described below), with the voids 14 also filled with oil in contact with the oil in the container. In practice, the stack would be held together with screwed rods and nuts (not shown), similar to those shown in and described with reference to FIG. 3.

FIG. 6 schematically illustrates an arrangement of a transformer enclosure comprising the transformer assembly mounted in a pressure equalizing housing in a subsea environment. This type of housing is itself known in the art. The transformer assembly 15 is ‘hung’ from a support framework 16, which in turn is attached to an assembly base plate 17 which provides the main attachment point for the assembly. A cavity 18 is shown within framework 16, which may house electrical control equipment (not shown), the cavity being defined by a housing (not shown) attached and sealed to base plate 17. The transformer assembly 15, framework 16 and cavity 18 are all housed within a thin-walled container 19, which is attached and sealed to the base plate 17. Container 19 is filled with electrically insulating oil in use, this oil being in communication and contact with the oil in the voids 14 of transformer assembly 15 housed in the container 19. A further thin-walled container 20 is attached to an external side of the container 19. Container 20 encloses a deformable oil-filled bladder 21, which is connected to container 19 via an orifice 22 such that oil may flow between bladder 21 and container 19. The interior of container 20 and exterior of the bladder 21 are exposed to the pressure of the environment, e.g. seawater, via an orifice 23 provided in an external wall of container 20. Using this configuration, the pressure of the oil in the transformer assembly 15 is made substantially equal to that of the surrounding seawater, through pressure transfer via the bladder 21. Since the pressures internal and external to containers 19 and 20 are substantially equal, the walls of the containers 19, 20 may safely be made thin-walled.

As described above, when the transformer is installed subsea for example, the oil pressure surrounding the transformer assembly 15 is substantially equal to the external seawater pressure. The oil filling the voids 14 between the core-elements will evenly distribute the oil-pressure, and so the core-elements will not be “pushed” one against the other. The possibility of core-elements “short-circuiting” one another is therefore eliminated.

In practice, the voids 14 between the laminations may be so small that the oil may have difficulty in penetrating them, due to surface tension effects. In this case, the transformer may therefore have to be ‘pre-treated’ before deployment (i.e. generally at a surface location before being deployed subsea), by: i) immersion of the transformer in an oil-filled container; ii) evacuation to remove the air from the voids 14; and iii) restoring the pressure back to atmospheric pressure, thus forcing the oil between the voids 14.

Such treatment is well-known for transformers which operate in oil, to remove any air pockets that may be present. The oil-filled container may for example have a wall thickness selected to withstand at least one bar of atmospheric pressure. The container is fitted with a pipe connection to a vacuum pump. Reducing the pressure inside the tank causes any air between the laminations to be removed. Releasing the vacuum results in the ambient pressure forcing the oil into the evacuated voids. The transformer may then be transferred to its resident oil-filled tank for operational use.

The oil in the voids 14 (which oil does not flow) allows hydrostatic pressure to be distributed in between the laminations provided by core-elements 11, 12, so that the laminations are not pushed or pressed against one another and cause electrical or mechanical damage.

The above-described embodiments are exemplary only, and other possibilities and alternatives within the scope of the embodiments of the present invention will be apparent to those skilled in the art. For example, an alternative arrangement to fixing the spacers to the core-elements by adhesive is to etch recesses, for example tapered grooves, in the core-elements to locate and retain the spacers. Although this is likely to make the core-elements more expensive, the cost of assembly is likely to be reduced.

The above-described embodiments show the use of “I” and “E” core-elements, however embodiments of the present invention are not so limited, and any other form or profile of lamination may be used the important aspect is that whatever the type of lamination or core-element, spacing is provided therebetween.

An alternative form of spacing means which could be used is an open-cell mesh sheet material which allows oil flow therethrough. In this case, the mesh could be cut into sheets of similar shape to each lamination and arranged therebetween. This embodiment has an advantage in that the spacing means is relatively easy to fit, and need not be adhered to a lamination, but is held in place by being “sandwiched” between adjacent laminations.

What is claimed is:

1. A transformer comprising:
a core formed from a plurality of planar laminations stacked together adjacent one another to lie substantially parallel;
electrically insulating spacing means provided between each of the laminations and a lamination adjacent thereto to separate them so as to provide a plurality of voids in the core, each of which is between a lamination and a lamination adjacent thereto; and
an electrically insulating fluid located within and filling said voids.

2. The transformer of claim 1, wherein each of the laminations comprises at least one core-element.

3. The transformer of claim 2, wherein each of the laminations comprises an “I” and an “E” type core-element.

4. The transformer of claim 1, wherein the spacing means comprises a plurality of spacers.

5. The transformer of claim 4, wherein for each lamination and a lamination adjacent thereto, the spacers are carried by a side of one of the laminations.

6. The transformer of claim 5, wherein the spacers are carried by being attached via adhesive.

7. The transformer of claim 5, wherein the spacers are carried by being located in recesses.

8. The transformer of claim 1, wherein the spacing means comprises a mesh sheet material.

9. The transformer of claim 1, wherein said electrically insulating fluid comprises oil.

10. The transformer of claim 4, wherein said electrically insulating fluid comprises oil.

11. The transformer of claim 5, wherein said electrically insulating fluid comprises oil.

12. A transformer enclosure comprising:
a housing filled with electrically insulating fluid;
a transformer mounted within the housing, the transformer comprising a core formed from a plurality of planar laminations stacked together adjacent one another to lie substantially parallel and electrically insulating spacing means provided between each of the laminations and a lamination adjacent thereto to separate them so as to provide a plurality of voids in the core, each of which is between a lamination and a lamination adjacent thereto, said electrically insulating fluid also being located within and filling said voids; and
a bladder configured to transfer the pressure external to the housing to the fluid in the housing such that in use the fluid resides at substantially the same pressure as that external to the enclosure.

13. The enclosure of claim 12, wherein the spacing means comprises a plurality of spacers.

14. The enclosure of claim 13, wherein for each lamination and a lamination adjacent thereto, the spacers are carried by a side of one of the laminations.

15. The enclosure of claim 14, wherein the spacers are carried by being attached via adhesive.

16. The enclosure of claim 14, wherein the spacers are carried by being located in recesses.

17. The enclosure of claim 12, wherein the spacing means comprises a mesh sheet material.

18. The enclosure of claim 12, wherein said electrically insulating fluid comprises oil.

19. An underwater facility comprising a transformer, the transformer comprising:
a core formed from a plurality of planar laminations stacked together adjacent one another to lie substantially parallel;
electrically insulating spacing means provided between each of the laminations and a lamination adjacent thereto to separate them so as to provide a plurality of voids in the core, each of which is between a lamination and a lamination adjacent thereto; and
an electrically insulating fluid located within and filling said voids.

20. A subsea hydrocarbon extraction facility comprising a transformer, the transformer comprising:
a core formed from a plurality of planar laminations stacked together adjacent one another to lie substantially parallel;
electrically insulating spacing means provided between each of the laminations and a lamination adjacent thereto to separate them so as to provide a plurality of voids in the core, each of which is between a lamination and a lamination adjacent thereto; and
an electrically insulating fluid located within and filling said voids.
